(19) United States
(12) Patent Application Publication
(10) Pub. No.: US 2017/0153385 A1
(43) Pub. Date: Jun. 1, 2017

(54) LIGHT GUIDING PLATE, BACKLIGHT MODULE AND DISPLAY DEVICE

(71) Applicant: Shenzhen China Star Optoelectronics Technology Co. Ltd., Shenzhen, Guangdong (CN)

(72) Inventor: Jianyu CHANG, Shenzhen, Guangdong (CN)

(73) Assignee: Shenzhen China Star Optoelectronics Technology Co. Ltd., Shenzhen, Guangdong (CN)

(21) Appl. No.: 14/783,989

(22) PCT Filed: Aug. 21, 2015
(86) PCT No.: PCT/CN2015/087783

§ 371 Date: Oct. 12, 2015

(30) Foreign Application Priority Data
Jul. 31, 2015 (CN) 201510465051.1

(51) Int. Cl. F21V 8/00

(52) U.S. Cl. CPC G02B 6/0088; G02B 6/0055

(57) ABSTRACT

The disclosure provides a light guiding plate and a backlight module. The backlight module comprises a plastic frame, a light source, an optical film sheet and a light guiding plate. The light guiding plate comprises an incident surface, an emitting surface and a bottom surface disposed opposite to the emitting surface. The incident surface connects with the bottom surface and the emitting surface. A reflective film layer is coated on the bottom surface. A grid point layer of the light guiding plate is disposed on the emitting surface. The light source is disposed at the side of the incident surface. The optical film sheet is stacked on the emitting surface. The plastic frame accommodates the light source, the optical film sheet and the light guiding plate. The disclosure further provides a display device.

### CROSS REFERENCE

This application claims the benefit of Chinese Patent Application No. 201510465051.6, filed Jul. 31, 2015, titled “Light guiding plate, backlight module and display device”, the entire contents of which are incorporated by reference herein in its entirety.

### FIELD OF THE INVENTION

The disclosure is related to the field of liquid crystal display, and more particularly, to a light guiding plate, a backlight module and a display device.

### BACKGROUND OF THE INVENTION

Currently, liquid crystal display devices are widely used in display units of electronic devices. As the electronic devices become thinner and thinner, the requirement of the brightness is more and more important, in addition, power-saving is another important requirement; backlight modules are important units in liquid crystal display devices.

The backlight module comprises a light guiding plate, a plastic disposed around the light guiding plate, a light source, a flexible circuit board, optical film sheet and so forth. The light source and the flexible circuit board are fixed to the light guiding plate and the plastic frame by a light shading tape. As a sided backlight module, the light emitted from the light source enters the light guiding plate, and is uniformly emitted outside through a grid point at the bottom of the light guiding plate. In general, part of the light would be emitted through the bottom surface of the light guiding plate. In addition, an optical film sheet is usually disposed on the top surface of the light guiding plate so as to increase brightness. However, the film sheet itself would absorb part of the light emitted from the light guiding plate, and the part of the light would further be emitted through the bottom surface of the light guiding plate, such that it causes the loss of lights.

### SUMMARY OF THE INVENTION

The disclosure seeks to solve the technical problem of providing a light guiding plate having a high usage of light source.

The disclosure further provides a backlight module and a display device.

In order to achieve the above purposes, the disclosure provides the following technical solutions:

The disclosure provides a light guiding plate. The light guiding plate comprises an incident surface, an emitting surface and a bottom surface disposed opposite to the emitting surface. The incident surface connects with the bottom surface and the emitting surface. A reflective film layer is coated on the bottom surface. A grid point layer of the light guiding plate is disposed on the emitting surface.

Wherein a reflective coating layer is disposed on an outer surface of the reflective film layer.

Wherein the reflective film layer is formed by a mixed foaming agent.

Wherein the reflective film layer is formed by a material having a refractive index smaller than a refractive index of the light guiding plate.

Wherein the mixed foaming agent is sodium bicarbonate.

Wherein the material having a refractive index smaller than a refractive index of the light guiding plate is magnesium fluoride.

Wherein a material of the reflective coating layer is silver or aluminum.

The disclosure provides a backlight module. The backlight module comprises a plastic frame, a light source, and an optical film sheet. The backlight module further comprises the light guiding plate. The light source is disposed at the side of the incident surface. The optical film sheet is stacked on the emitting surface. The plastic frame accommodates the light source, the optical film sheet and the light guiding plate.

Wherein the light source comprises an aluminum substrate and a LED light disposed on the aluminum substrate. The aluminum substrate is fixed with the plastic frame. The LED light is disposed opposite to the incident surface.

The disclosure provides a display device. The display device comprises a backlight module and a liquid crystal panel. The backlight module comprises a plastic frame, a light source, an optical film sheet and a light guiding plate. The light guiding plate comprises an incident surface, an emitting surface and a bottom surface disposed opposite to the emitting surface. The incident surface connects with the bottom surface and the emitting surface. A reflective film layer is coated on the bottom surface. A grid point layer of the light guiding plate is disposed on the emitting surface. The light source is disposed at the side of the incident surface. The optical film sheet is stacked on the emitting surface. The plastic frame accommodates the light source, the optical film sheet and the light guiding plate. The liquid crystal panel is disposed on the backlight module, and the liquid crystal panel and the plastic frame are fixed by a double-sided adhesive.

According to the disclosure, the backlight module comprises a light guiding plate having a reflective film layer at the bottom, such that it can reduce the problem that light of the sided light source entering the light guiding plate and leaking from the bottom surface of the light surface, it improves the usage of the light source, it does not need the reflective sheet, it does not a back plate support the reflective sheet, and it can reduce the thickness of the backlight module.

### BRIEF DESCRIPTION OF THE DRAWINGS

In order to more clearly illustrate the embodiments of the disclosure, the accompanying drawings for illustrating the technical solutions and the technical solutions of the disclosure are briefly described as below.

FIG. 1 is a sectional view of the light guiding plate according to a preferred embodiment of the disclosure;

FIG. 2 is a sectional view of the backlight module according to the embodiment of the disclosure; and

FIG. 3 is a sectional view of the light guiding plate according to another embodiment of the disclosure.

### DETAILED DESCRIPTION OF THE DRAWINGS

The following description with reference to the accompanying drawings is provided to clearly and completely explain the exemplary embodiments of the disclosure. It is apparent that the following embodiments are merely some embodiments of the disclosure rather than all embodiments of the disclosure. According to the embodiments in the disclosure, all the other embodiments attainable by those skilled in the art without creative endeavor belong to the protection scope of the disclosure.

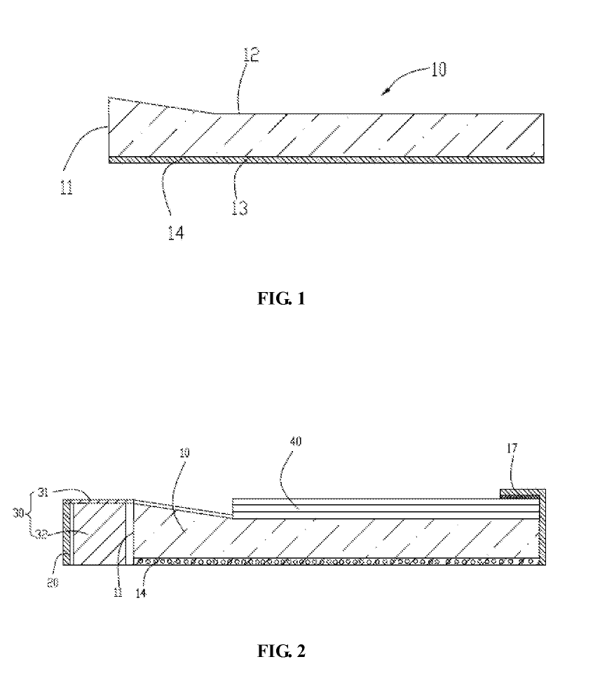

Referring to FIG. 1, according to a preferred embodiment of the disclosure, a light guiding plate 10 used in a backlight module is provided. The light guiding plate 10 comprises an incident surface 11, an emitting surface 12 and a bottom surface 13 disposed opposite to the emitting surface 12. The incident surface 11 connects with the bottom surface 13 and the emitting surface 12. A reflective film layer 14 is coated on the bottom surface 13. A grid point layer (not shown in figure) of the light guiding plate is disposed on the emitting surface 12.

In this embodiment, the light guiding plate 10 is a rectangular plate. The grid point layer is disposed on the emitting surface 12 of the light guiding plate 10, when coordinating with the reflective film layer 14 of the bottom surface 13, light entering from the incident surface of the light guiding plate and light reflected from the reflective film layer 14 are both scattered uniformly and emit outside the emitting surface 12. As compared with the grid point layer disposed at the bottom, all the light inside the light guiding plate can be scattered as much as possible, such that it can avoid the problem that the light reflected back from the reflective structure is not scattered and further affects the uniformity of the light surface of the light guiding plate. In this embodiment, the grid point layer is formed by laser grid method.

In the first embodiment of the disclosure, the reflective film layer 14 is formed on the bottom surface 13 by a mixed foaming agent through coating. Preferably, the mixed foaming agent is sodium bicarbonate. In this embodiment, the light guiding plate 10 is treated under a normal temperature, and the reflective film layer 14 reacts without generating air bubbles. The air bubbles are arranged inside the reflective film layer and cause reflection, which reflect the light, which enters toward the bottom surface 13 of the light guiding plate, toward the emitting surface 12 and the light leaves the light guiding plate 10 through the grid point payer, such that it can avoid the problem that the light is emitted through the bottom surface 13 and causes the loss of the light source.

Preferably, a reflective coating layer (not shown in the figure) is disposed on an outer surface of the reflective film layer 14, configured for collecting the light leaking outside the reflective film layer 14 from the light guiding plate, such that the usage of the light source is further improved.

Referring to FIG. 2, according to a preferred embodiment of the disclosure backlight module is provided. The backlight module comprises a light guiding plate 10, a plastic frame 20, a light source 30, and an optical film sheet 40. The plastic frame 20 accommodates the light source 30, the optical film sheet 40 and the light guiding plate 10. The optical film sheet 40 is stacked on the emitting surface 12 of the light guiding plate 10. The light source 30 is disposed at the side of the incident surface 11. It should be noticed that the reflective film layer 14 of the light guiding plate 10 shown in FIG. 2 is in a reacted status after heating (the heat source is the heat generated by the light source 30 or the heat of inner elements, such as terminal board of the module), in which air bubbles are generated, such that total reflection is achieved, and all the light of the bottom of the light guiding plate 10 is reflected back to the emitting surface.

In this embodiment, the plastic frame 20 is a rectangular frame and surrounds the peripheral of the light guiding plate 10. The edge of the optical film sheet 40 is fixed with the plastic frame by a double-sided adhesive 17. The light source 30 is toward the incident surface 11 of the light guiding plate 10. The light source 30 comprises an aluminum substrate 31 and a LED light 32 disposed on the aluminum substrate 31. The aluminum substrate 31 is fixed with the plastic frame. The LED light 32 is disposed opposite to the incident surface 11.

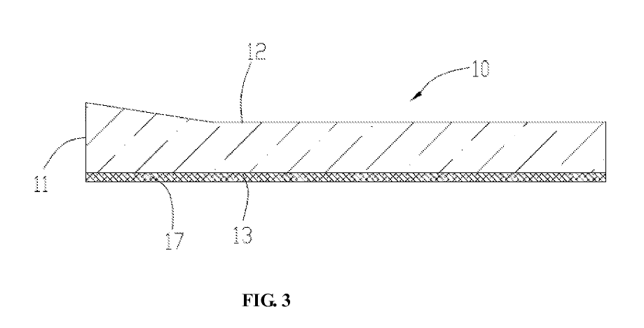

Referring to FIG. 3, in another embodiment of the disclosure, the reflective film layer 17 is formed by a material having a refractive index smaller than a refractive index of the light guiding plate 10. Wherein, the material having a refractive index smaller than a refractive index of the light guiding plate can be magnesium fluoride.

According to the disclosure, the backlight module comprises a light guiding plate 10 having a reflective film layer at the bottom, such that it can reduce the problem that light of the sided light source entering the light guiding plate and leaking from the bottom surface of the light surface 10, it improves the usage of the light source, it does not need the reflective sheet, it does not a back plate supporting the reflective sheet, and it can reduce the thickness of the backlight module.

The disclosure further provides a display device (not shown in the figures). The display device comprises the backlight module and a liquid crystal panel. The liquid crystal panel is disposed on the backlight module, and the liquid crystal panel and the plastic frame are fixed by a double-sided adhesive. The display device can be a mobile phone, a PDA, a display and so forth.

Note that the specifications relating to the above embodiments should be construed as exemplary rather than as limitative of the present disclosure. The equivalent variations and modifications on the structures or the process by reference to the specification and the drawings of the disclosure, or application to the other relevant technology fields directly or indirectly should be construed similarly as falling within the protection scope of the disclosure.

What is claimed is:

1. A light guiding plate, comprising:
an incident surface;
an emitting surface; and
a bottom surface, disposed opposite to the emitting surface;
wherein, the incident surface connects with the bottom surface and the emitting surface;
wherein, a reflective film layer is coated on the bottom surface, and a grid point layer of the light guiding plate is disposed on the emitting surface.

2. The light guiding plate according to claim 1, wherein a reflective coating layer is disposed on an outer surface of the reflective film layer.

3. The light guiding plate according to claim 1, wherein the reflective film layer is formed by a mixed foaming agent.

4. The light guiding plate according to claim 1, wherein the reflective film layer is formed by a material having a refractive index smaller than a refractive index of the light guiding plate.

5. The light guiding plate according to claim 3, wherein the mixed foaming agent is sodium bicarbonate.

6. The light guiding plate according to claim 4, wherein the material having a refractive index smaller than a refractive index of the light guiding plate is magnesium fluoride.

7. The light guiding plate according to claim 2, wherein a material of the reflective coating layer is silver or aluminum.

8. A backlight module, comprising:
a plastic frame;
a light source; and
an optical film sheet;
wherein the backlight module further comprises the light guiding plate, the light source is disposed at the side of the incident surface, the light guiding plate comprises an incident surface, an emitting surface and a bottom surface disposed opposite to the emitting surface, the incident surface connects with the bottom surface and the emitting surface, a reflective film layer is coated on the bottom surface, a grid point layer of the light guiding plate is disposed on the emitting surface, the optical film sheet is stacked on the emitting surface, and the plastic frame accommodates the light source, the optical film sheet and the light guiding plate.

9. The backlight module according to claim 8, wherein a reflective coating layer is disposed on an outer surface of the reflective film layer.

10. The backlight module according to claim 8, wherein the reflective film layer is formed by a mixed foaming agent.

11. The backlight module according to claim 8, wherein the reflective film layer is formed by a material having a refractive index smaller than a refractive index of the light guiding plate.

12. The backlight module according to claim 10, wherein the mixed foaming agent is sodium bicarbonate.

13. The backlight module according to claim 11, wherein the material having refractive index smaller than a refractive index of the light guiding plate magnesium fluoride.

14. The backlight module according to claim 9, wherein a material of the reflective coating layer is silver or aluminum.

15. The backlight module according to claim 8, wherein the light source comprises an aluminum substrate and a LED light disposed on the aluminum substrate, the aluminum substrate is fixed with the plastic frame, and the LED light is disposed opposite to the incident surface.

16. A display device, comprising
a backlight module, comprising:
a plastic frame;
a light source;
an optical film sheet; and
a light guiding plate;
wherein, the light guiding plate comprises an incident surface, an emitting surface and a bottom surface disposed opposite to the emitting surface, the incident surface connects with the bottom surface and the emitting surface, a reflective film layer is coated on the bottom surface, a grid point layer of the light guiding plate is disposed on the emitting surface, the light source is disposed at the side of the incident surface, the optical film sheet is stacked on the emitting surface, and the plastic frame accommodates the light source, the optical film sheet and the light guiding plate; and
a liquid crystal panel, disposed on the backlight module, and the liquid crystal panel and the plastic frame are fixed by a double-sided adhesive.
